(19) United States
(12) Patent Application Publication
(10) Pub. No.: US 2006/0104255 A1
(43) Pub. Date: May 18, 2006

(54) Broadcast data transmission/reception system and broadcast data transmission/reception method

(76) Inventors: Kiyonori Kido, OSAKA (JP); Kazuhiko Hirayama, Suita-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/530,911

(22) PCT Filed: Oct. 10, 2003
(86) PCT No.: PCT/JP03/13025

§ 371 Date: Sep. 20, 2005

(30) Foreign Application Priority Data
Oct. 10, 2002 (JP) 2002-297305

(51) Int. Cl. H04J 3/00

(52) U.S. Cl. 370/345; 370/395.4

(57) ABSTRACT

A broadcast data transmission/reception system (100) includes: a transmitter (700) for transmitting broadcast data including time information indicating a reproduction start time; and a receiver (800) for receiving the broadcast data. The transmitter (700) transmits, at least a predetermined amount of time prior to transmitting the broadcast data, substitutive broadcast data including a same content as the broadcast data and time information indicating the reproduction start time, and a substitutive identifier one or more times. The receiver (800) tries to obtain the substitutive broadcast data based on the substitutive identifier specified by an identifier specifier. The receiver (800) reproduces, at the reproduction start time, one of the broadcast data and the substitutive broadcast data if successfully obtained.

### TECHNICAL FIELD

The present invention relates to a broadcast data transmission/reception system, and in particular to a transmission/reception system used for digital broadcasting.

### BACKGROUND ART

BS digital broadcasting, which is already in operation, usually multiplexes and transmits various broadcast data, such as video data and audio data constituting broadcast programs, and still images and textual information constituting data-broadcasting programs.

In BS digital broadcasting, MPEG-2 Transport Stream (hereinafter called “TS”) multiplex method is used as a method for multiplexing such various broadcast data.

Here, “TS” means a data stream that is standardized in ISO/IEC13818-1. More specifically, it is a data stream having a data size fixed to 188 bytes and including a plurality of TS packets. The various data is divided into pieces, and each piece of the data is to be carried by a TS packet.

In MPEG-2 TS multiplex method, various broadcast data as a target of the multiplex and control information are divided into TS packets to be transmitted. The control information includes PSI (Program Specific Information) that indicates relations between broadcast programs and various broadcast data, values of PIDs of TS packets, and so on.

A conventional digital broadcast transmission/reception system 1000 for transmitting/receiving digital broadcast includes a transmitter 1500 and a receiver 1600.

FIG. 15 is a functional block diagram showing a structure of a main part of the transmitter 1500. The transmitter 1500 includes encoder units 1501a₁ to 1501aₙ, a PSI/SI providing unit 1502, a TS multiplex unit 1503, and an STC (System Time Clock) unit 1505.

Each of the encoder units 1501a₁ to 1501aₙ encodes various broadcast data to generate a PES (Packetized Elementary Stream) packet, and transmits the PES packet to the TS multiplex unit 1503.

In the process of generating the PES packet, each of the encoder units 1501a₁ to 1501aₙ generates a PTS (Presentation Time Stamp) and a DTS (Decoding Time Stamp) based on an STC (System Time Clock) received from the STC unit 1505, which indicates a base time of the transmitter 1500. Then, each of the encoder units 1501a₁ to 1501aₙ encodes the generated PTS and DTS, and adds the encoded PTS and DTS to the PES packet.

Here the “PES packet” has a variable-length data structure, and includes a PES header storing control information and a PES payload storing data (various broadcast data).

Each PES packet stores a unit of meaningful data, for instance, video data for one frame. The PTS and the DTS are stored in the PES header as control information. The data structure of the PES packet is to be described later in detail.

Note that the “PTS” is time information that indicates a reproduction start time of data stored in the PES payload, and the “DTS” is time information that indicates a decoding start time of data stored in the PES payload.

The PSI/SI providing unit 1502 outputs source information for generating a PSI and an SI (Service Information) to the TS multiplex unit 1503.

Here, the PSI is apiece of information used for identifying a broadcast channel. The PSI includes a PAT (Program Association Table), a PMT (Program Map Table), and so on.

The SI is a piece of program information indicating a title of a broadcast program, a start/end time of the broadcast program, and so on.

The STC unit 1505 generates and outputs the STC to each of the encoder units 1501a₁ to 1501aₙ. Further, the STC unit 1505 repeatedly generates and outputs a PCR (Program Clock Reference) to the TS multiplex unit 1503 at predetermined intervals.

The “PCR” is a piece of base time information indicating the same time the STC indicates. The “PCR” is generated at predetermined intervals, output from the STC unit 1505 to the TS multiplex unit 1503, stored in the TS packet, and transmitted to each receiver in order to synchronize the base time of each receiver for receiving broadcast data to the base time of the transmitter 1500.

The TS multiplex unit 1503 includes a PSI/SI generation unit 1504. The TS multiplex unit divides each PES packet received from the encoder units 1501a₁ to 1501aₙ, the PSI and the SI generated by the PSI/SI generation unit 1504, and the PCR received from the STC unit 1505 into TS packets respectively, each having a fixed data length. These TS packets are to be transmitted by time division multiplexing.

The PSI/SI generation unit 1504 generates the PSI and the SI based on the source information provided by the PSI/SI providing unit 1504.

FIG. 16 is a functional block diagram showing a main part of the conventional receiver 1600. The receiver 1600 includes a TS separation unit 1601, a PSI/SI analysis and control unit 1602, transport buffer units 1603a₁ to 1603aₙ, decoder buffer units 1604a₁ to 1604aₙ, decoder units 1605a₁ to 1605aₙ, and an STC unit 1606.

The TS separation unit 1601 performs TS packet separation processing, which is described next.

When a radio reception unit 1608 receives, via an antenna 1607, a TS which is transmitted from the transmitter 1500, the TS separation unit 1601 separates a TS packet including the PSI (more specifically a TS packet including a PAT. Such a TS packet is hereinafter called a “PAT packet”.) from the received TS, and outputs the separated TS packet to the PSI/SI analysis and control unit 1602.

Further, when receiving a specification of the PID of a TS packet including a PMT (hereinafter called a “PMT packet”) from the PSI/SI analysis and control unit 1602, based on the analysis result of the PAT included in the PAT packet, the TS separation unit 1601 separates the PMT packet having the specified PID from the received TS, and outputs the separated PMT packet to the PSI/SI analysis and control unit 1602.

Further, when receiving specifications of the PIDs of a TS packet including a PCR (hereinafter called a “PCR packet”) and TS packets constituting a broadcast program (hereinafter called “program packets”) of a broadcast channel specified by a user via an input unit (not illustrated) from the PSI/SI analysis and control unit 1602, based on the analysis result of the PMT included in the PMT packet, the TS separation unit 1601 outputs each separated program packet to a transport buffer unit corresponding to the specified PID of the program packet, and outputs the separated PCR packet to the STC unit 1606.

The PSI/SI analysis and control unit 1602 performs separated TS packet specification processing, which is described next.

The PSI/SI analysis and control unit 1602 refers to the PAT included in the TS packet including the PSI, which is received from the TS separation unit 1601, and identifies the PID of the PMT packet corresponding to the broadcast channel specified by the user via the input unit (not illustrated). Then, the PSI/SI analysis and control unit 1602 transmits a specification of the identified PID to the TS separation unit 1601 as the PID of the PMT packet which should be separated.

Further, the PSI/SI analysis and control unit 1602 refers to the description in the PMT of the TS packet, and identifies the PIDs of the program packets and the PCR packet. Then, the SPI/SI analysis and control unit 1602 transmits specifications of the identified PIDs to the TS separation unit 1601 as the PIDs of the TS packets which should be separated.

The transport buffer units 1603a₁ to 1603aₙ respectively store the TS packets whose PIDs are received from the TS separation unit 1601, in units of several pieces (at least one piece) of the PES packets. Then, each of the transport buffer units 1603a₁ to 1603aₙ outputs the stored PES packet to the corresponding one of the decoder buffer units 1604a₁ to 1604aₙ at predetermined intervals.

Each of the decoder buffer units 1604a₁ to 1604aₙ stores the PES packet received from the corresponding transport buffer unit.

The STC unit 1606 adjusts the STC belonging to the receiver 1600 to synchronize with the STC belonging to the transmitter 1500 based on the base time information for the transmitter 1500 indicated by the PCR packet received from the TS separation unit 1601, and outputs the adjusted STC to the decoder units 1605a₁ to 1605aₙ.

Each of the decoder units 1605a₁ to 1605aₙ reads out the PES packet from the corresponding one of the decoder buffer units 1604a₁ to 1604aₙ, and decodes and reproduces the read-out PES packet according to the times indicated by the PTS and the DTS included in the PES packet stored in the corresponding decoder buffer unit.

More specifically, each of the decoder units 1605a₁ to 1605aₙ judges whether or not the current time is the time indicated by the PTS or the DTS, by comparing the PTS or the DTS and the time indicated by the adjusted STC received from the STC unit 1606. In the case where the current time is the time indicated by the PTS or the DTS, each of the decoder units 1605a₁ to 1605aₙ reads out the PES packet from the corresponding decoder buffer unit, and decodes and reproduces the PES packet.

With the stated structure, each receiver can reproduce the various broadcast data transmitted from the transmitter 1500, at a reproduction start time that is set to the transmitter 1500. Thus the viewers can view desired digital broadcast programs.

Meanwhile, in a transmission system using a wireless network, such as BS digital broadcasting, if the condition of the transmission channel is poor due to bad weather, such as heavy rain or a fading and so on, the broadcast wave for carrying video and audio data might be interrupted in the middle of the transmission. In this case, the receiver cannot reproduce video and audio temporally, and might cause problems, such as intermittence of video, and noise.

For solving such problems, there is a method for repeatedly transmitting the same piece of information a plurality of times at predetermined intervals. This method is used in DSM-CC (Digital Storage Media Command and Control) described in Annex B of ISO/IEC13818-1.

With this method, the receiver can reproduce complete data by receiving only one of the pieces of information repeatedly transmitted from the transmitter. This allows the receiver to reproduce complete video and audio data even when the condition of the transmission channel becomes poor while receiving the digital broadcast and the receiver can not receive the broadcast wave temporally.

However, frequency of such situation, in which the receiver can not receive the broadcast wave temporally, depends on the location where the receiver is placed. Therefore, if all the receivers for receiving the digital broadcast are set up to obtain the same broadcast data in the broadcast wave a plurality of times, the problem is that a receiver in a location where rarely encounters such situation has to perform redundant processing, in which the receiver obtains the same broadcast data a plurality of times.

### DISCLOSURE OF THE INVENTION

In view of the above problem, the present invention aims to provide a broadcast data transmission/reception system using a transmission method in which a transmitter transmits substitutive broadcast data before transmitting broadcast data that should be reproduced at a time of actual telecast. In this broadcast data transmission/reception system, a receiver that performs processing for obtaining the substitutive broadcast data and a receiver that does not perform such processing can coexist without problems.

The object can be achieved by a broadcast data transmission/reception system that includes a transmitter, a first receiver and a second receiver, the transmitter transmitting broadcast data including time information indicating a reproduction start time, and both the first and second receivers trying to obtain the broadcast data, wherein the transmitter further transmits, at least a predetermined amount of time prior to transmitting the broadcast data, substitutive broadcast data and a substitutive identifier one or more times, the substitutive broadcast data including a same content as the broadcast data and time information indicating the reproduction start time, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the reproduction start time, one of the broadcast data and the substitutive broadcast data if successfully obtained.

Here, “the first receiver” is a receiver having a function for receiving the broadcast data and not having a function for receiving the substitutive broadcast data, just as the conventional receiver 1600.

Here, the transmitter may transmit pieces of the broadcast data having different reproduction start times respectively, and the transmitter may further transmit, at least the predetermined amount of time prior to transmitting the pieces of the broadcast data, pieces of the substitutive broadcast data respectively corresponding to the pieces of the broadcast data one or more times, each piece of the substitutive broadcast data including a same content as a corresponding piece of the broadcast data and time information indicating a same reproduction start time as a reproduction start time of the corresponding piece of the broadcast data. The broadcast data obtaining unit may try to obtain the piece of the substitutive broadcast data based on the substitutive identifier specified by the identifier specifier, and the reproducing unit may reproduce, at the reproduction start time, one of the piece of the broadcast data and the piece of the substitutive broadcast data if successfully obtained.

Also, the present invention may be a second receiver that tries to obtain broadcast data including time information indicating a reproduction start time, a first receiver trying to obtain the broadcast data, wherein the second receiver further tries to obtain substitutive broadcast data and a substitutive identifier which are transmitted one or more times at least a predetermined amount of time prior to a time when the broadcast data is transmitted, the substitutive broadcast data including a same content as the broadcast data and time information indicating the reproduction start time, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the reproduction start time, one of the broadcast data and the substitutive broadcast data if successfully obtained.

Here, the second receiver may receive pieces of the broadcast data having different reproduction start times respectively, and may further receive pieces of the substitutive broadcast data corresponding to the pieces of the broadcast data respectively, each piece of the substitutive broadcast data being transmitted one or more times at least a predetermined amount of time prior to a time when the broadcast data is transmitted, and including a same content as a corresponding piece of the broadcast data and time information indicating a same reproduction start time as a reproduction start time of the corresponding piece of the broadcast data. The broadcast data obtaining unit may try to obtain the piece of the substitutive broadcast data based on the substitutive identifier specified by the identifier specifier, and the reproducing unit may reproduce, at the reproduction start time, one of the piece of the broadcast data and the piece of the substitutive broadcast data if successfully obtained.

Also, the present invention may be a transmitter, comprising: a first transmission unit operable to transmit broadcast data including time information indicating a reproduction start time, both a first receiver and a second receiver trying to obtain the broadcast data; and a second transmission unit operable to transmit, at least a predetermined amount of time prior to a time when the first transmission unit transmits the broadcast data, substitutive broadcast data and a substitutive identifier one or more times, the substitutive broadcast data including a same content as the broadcast data and time information indicating the reproduction start time.

With the stated structure, even if the transmitter transmits the substitutive broadcast data as compensative data including the same content as the broadcast data in case the broadcast data is lost in the middle of the transmission, only specific receivers perform processing for obtaining the substitutive broadcast data, and other receivers perform only processing for obtaining the broadcast data. Therefore, in the case where the broadcast data can not obtained temporally, the specific receivers can reproduce the substitutive broadcast data without burdening other receivers.

Here, the broadcast data obtaining unit may include: a recording medium; and a recording subunit operable to record, on the recording medium, whichever of the substitutive broadcast data and the broadcast data is obtained first, and the reproducing unit may reproduce, at the reproduction start time, whichever of the substitutive broadcast data and the broadcast data is recorded on the recording medium.

With the stated structure, the receiver that performs the processing for obtaining the substitutive broadcast data does not redundantly record the broadcast data and the substitutive broadcast data having the same content. This reduces the size of memory used for recording the data.

Here, each of the broadcast data and the substitutive broadcast data may include a plurality of data elements. The broadcast data obtaining unit may include a judging subunit for judging whether the broadcast data or the substitutive broadcast data includes all the data elements, every time the broadcast data obtaining unit receives the broadcast data or the substitutive broadcast data. The broadcast data obtaining unit may obtain the broadcast data or the substitutive broadcast data only when a judgment result by the judging subunit is affirmative.

Also, each of the plural pieces of the broadcast data and the plural pieces of the substitutive broadcast data may include a plurality of data elements. The broadcast data obtaining unit may include a judging subunit for judging whether the broadcast data or the substitutive broadcast data includes all the data elements, every time the broadcast data obtaining unit receives the broadcast data or the substitutive broadcast data. The broadcast data obtaining unit may obtain the broadcast data or the substitutive broadcast data only when a judgment result by the judging subunit is affirmative.

This allows the receiver that performs processing for obtaining the substitutive broadcast data to record which ever of the broadcast data or the substitutive broadcast data is without any loss. Therefore, even if the broadcast wave can not be obtained temporally, the receiver can reproduce complete video and audio based on whichever of the broadcast data or the substitutive broadcast data is without any loss.

Also, the present invention may be a broadcast data transmission/reception system that includes a transmitter, a first receiver and a second receiver, the transmitter transmitting broadcast data including time information indicating a first reproduction start time, and both the first and second receivers trying to obtain the broadcast data, wherein the broadcast data is a piece of still images that constitute a moving picture and have sequential reproduction start times respectively, the transmitter further transmits, at least a predetermined amount of time prior to transmitting the broadcast data, substitutive broadcast data and a substitutive identifier one or more times, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the first reproduction start time, the broadcast data if successfully obtained, and reproduce, at the second reproduction start time, the substitutive broadcast data if successfully obtained.

Also, the present invention may be a second receiver that tries to obtain broadcast data including time information indicating a reproduction start time, a first receiver trying to obtain the broadcast data, wherein the broadcast data is a piece of still images that constitute a moving picture and have sequential reproduction start times respectively, the second receiver further receives substitutive broadcast data and a substitutive identifier which are transmitted one or more times at least a predetermined amount of time prior to a time when the broadcast data is transmitted, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the first reproduction start time, the broadcast data if successfully obtained, and reproduce, at the second reproduction start time, the substitutive broadcast data if successfully obtained.

Also the present invention may be a transmitter, comprising: a first transmission unit operable to transmit broadcast data including time information indicating a first reproduction start time, the broadcast data being a piece of still images that constitute a moving picture and have sequential reproduction start times respectively, and both a first receiver and second receiver trying to obtain the broadcast data; and a second transmission unit operable to transmit, at least a predetermined amount of time prior to a time when the first transmission unit transmits the broadcast data, substitutive broadcast data and a substitutive identifier one or more times, the substitutive broadcast data being a piece of still images that constitute the moving picture, and including time information indicating a second reproduction start time that is next to the first reproduction start time among the sequential reproduction start times, the substitutive identifier being for identifying the substitutive broadcast data, and only the second receiver trying to obtain the substitutive broadcast data and the substitutive identifier.

Also, the present invention may be a broadcast data transmission/reception method used for a broadcast data transmission/reception system that includes a transmitter, a first receiver and a second receiver, the transmitter transmitting broadcast data including time information indicating a first reproduction start time, the broadcast data being a piece of still images that constitute a moving picture and have sequential reproduction start times respectively, both the first and second receivers trying to obtain the broadcast data, and the broadcast data transmission/reception method comprising steps of: transmitting, by the transmitter, substitutive broadcast data and a substitutive identifier one or more times at least a predetermined amount of time prior to transmitting the broadcast data, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data; trying, by the second receiver that includes a storing unit for storing therein an identifier specifier for specifying the substitutive identifier, to obtain the substitutive broadcast data based on the substitutive identifier specified by the identifier specifier, and to obtain the broadcast data based on the identifier; and reproducing, at the first reproduction start time, the broadcast data if successfully obtained, and reproducing, at the second reproduction start time, the substitutive broadcast data if successfully obtained.

With the stated structure, the second receiver can reproduce video that closely resembles video based on the broadcast data lost in the middle of the transmission, based on the substitutive broadcast data without receiving redundant data, where the broadcast data and the substitutive broadcast data having consecutive reproduction start times. This improves the transmission efficiency. Also, if both the broadcast data and the substitutive broadcast data are obtained without any loss, the second receiver reproduces video based on both the broadcast data and the substitutive broadcast data. Therefore, the second receiver can reproduce video with higher image quality than the video based on only one of the broadcast data and the substitutive broadcast data.

Also, the present invention may be a broadcast data transmission/reception system that includes a transmitter, a first receiver and a second receiver, the transmitter transmitting broadcast data including time information indicating a reproduction start time, and both the first and second receivers trying to obtain the broadcast data, wherein the broadcast data includes a plurality of data elements, the transmitter further transmits, at least a predetermined amount of time prior to transmitting the broadcast data, substitutive broadcast data and a substitutive identifier one or more times, the substitutive broadcast data including a predetermined member among the data elements and time information indicating the reproduction start time, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the reproduction start time, only the broadcast data if successfully obtained, and reproduce, at the reproduction start time, the substitutive broadcast data in a case where the broadcast data obtaining unit has failed to obtain the broadcast data and succeeded in obtaining the substitutive-broadcast data.

Also, the present invention may be a second receiver that tries to obtain broadcast data including time information indicating a reproduction start time, a first receiver trying to obtain the broadcast data, wherein the broadcast data includes a plurality of data elements, the second receiver further receives substitutive broadcast data and a substitutive identifier which are transmitted one or more times at least a predetermined amount of time prior to a time when the broadcast data is transmitted, the substitutive broadcast data including a predetermined member among the data elements and time information indicating the reproduction start time, and the substitutive identifier being for identifying the substitutive broadcast data, and the second receiver further includes: a storing unit that stores therein an identifier specifier for specifying the substitutive identifier; a broadcast data obtaining unit operable to try to obtain the substitutive broadcast data based on the substitutive identifier specified by the identifier specifier; and a reproducing unit operable to reproduce, at the reproduction start time, only the broadcast data if successfully obtained, and reproduce, at the reproduction start time, the substitutive broadcast data in a case where the broadcast data obtaining unit has failed to obtain the broadcast data and succeeded in obtaining the substitutive broadcast data.

Also, the present invention may be a broadcast data transmission/reception method used for a broadcast data transmission/reception system that includes a transmitter, a first receiver and a second receiver, the transmitter transmitting broadcast data including time information indicating a reproduction start time, the broadcast data including a plurality of data elements, both the first and second receivers trying to obtain the broadcast data, and the broadcast data transmission/reception method comprising steps of: transmitting, by the transmission system, substitutive broadcast data and a substitutive identifier one or more times at least a predetermined amount of time prior to transmitting the broadcast data, the substitutive broadcast data including a predetermined member among the data elements and time information indicating the reproduction start time, and the substitutive identifier being for identifying the substitutive broadcast data; trying, by the second receiver that includes a storing unit for storing therein an identifier specifier for specifying the substitutive identifier, to obtain the substitutive broadcast data based on the substitutive identifier specified by the identifier specifier; and reproducing, at the reproduction start time, only the broadcast data if successfully obtained, and reproducing, at the reproduction start time, the substitutive broadcast data only if the broadcast data has not been obtained and only the substitutive broadcast data has been obtained.

Here, the broadcast data may constitute a GOP (Group of Picture) encoded by MPEG (Moving Picture Expert Group) method, and the substitutive broadcast data may constitute an I-picture, which is a data element included in the GOP.

Also, the broadcast data may constitute a GOP (Group of Picture) encoded by MPEG (Moving Picture Expert Group) method, and the substitutive broadcast data may constitute an I-picture and a P-picture, which are data elements included in the GOP.

With the stated structure, the second receiver can reproduce the main part of the video corresponding to the broadcast data which is lost in the middle of transmission, based on the data elements being included in the substitutive data and constituting the same content as the main part of the lost broadcast data, without receiving the whole body of the broadcast data redundantly. The data elements not constituting the main part are not transmitted as the substitutive data. Therefore the size of the substitutive data that is to be transmitted can be reduced.

### BRIEF DESCRIPTION OF THE DRAWINGS

FIG. 1 shows a structure of a main part of a broadcast data transmission/reception system 100 of the embodiment;

FIG. 2A is a specific example showing standard packet PIDs and a content of rewritten PCR, which are described in a PMT;

FIG. 2B is a specific example showing a preceding packet PID described in an RIT;

FIG. 3 schematically shows a specific example of a TS transmitted from a transmitter 700;

FIG. 4 shows a specific example of a TS transmitted from the transmitter 700 in case where its TS packets are partially lost in the middle of transmission;

FIG. 5 shows a structure of a PES packet;

FIG. 6A shows a preceding PES packet (PES1) transmitted via the TS shown in FIG. 4 without losing any preceding TS packets;

FIG. 6B shows a standard PES packet (PES1) transmitted via the TS shown in FIG. 4, whose standard TS packets are partially lost;

FIG. 6C shows a preceding PES packet (PES2) transmitted via the TS shown in FIG. 4, whose standard TS packets are partially lost;

FIG. 6D shows a standard PES packet (PES2) transmitted via the TS shown in FIG. 4 without losing any preceding TS packets;

FIG. 7 is a functional block diagram showing a structure of a main part of the transmitter 700;

FIG. 8 is a functional block diagram showing a structure of a main part of the transmitter 800;

FIG. 9 is a flowchart showing TS packet separation processing performed by a receiver 800;

FIG. 10 is a flowchart showing PES packet output control processing performed by buffer control units 807a₁ to 807aₙ;

FIG. 11 shows a data structure of an RIT;

FIG. 12A shows a specific example of frame images constituting a moving picture displayed by interlaced scanning;

FIG. 12B shows a specific example of frame images constituting a moving picture displayed by progressive scanning, which are sequential in terms of time;

FIG. 13 is a functional block diagram showing a main part of a receiver 1300;

FIG. 14 shows an image displayed in the case where a PES1 is received and reproduced by a receiver 800, and an image displayed in the case where a PES1 is received and reproduced by a receiver 1600;

FIG. 15 is a functional block diagram showing a structure of a main part of a transmitter 1500;

FIG. 16 is a functional block diagram showing a main part of a conventional receiver 1600; and

FIG. 17 is a flowchart showing TS packet separation processing operated by a receiver 1600.

### BEST MODE FOR CARRYING OUT THE INVENTION

The following describes a broadcast data transmission/reception system pertaining to an embodiment of the present invention, with reference to the figures.

Structure

The following describes a broadcast data transmission/reception system pertaining to the present invention in detail, with reference to the figures.

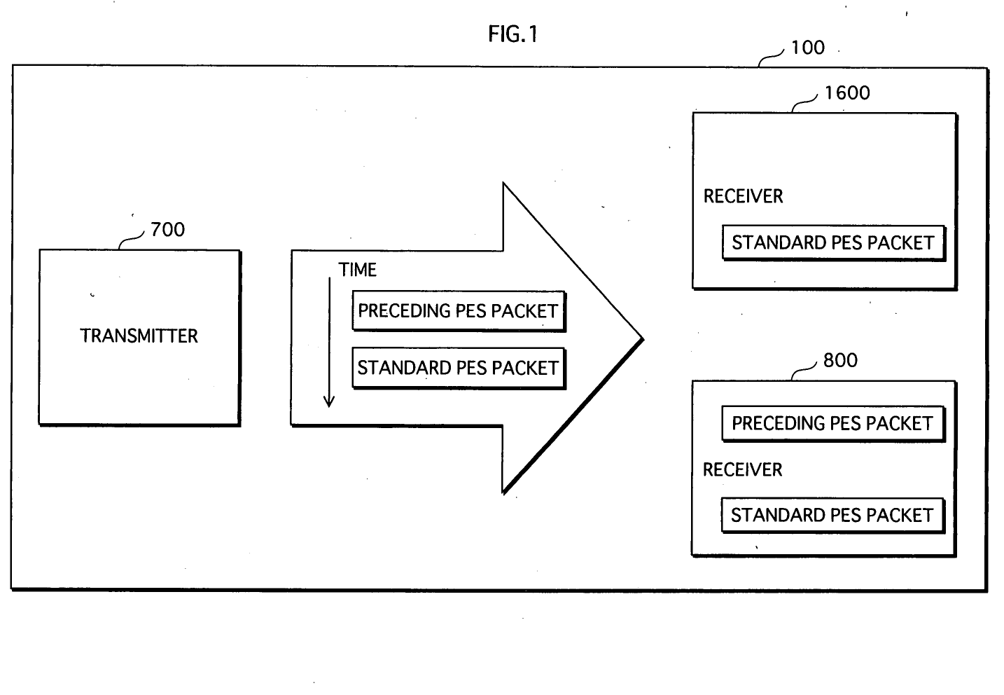

FIG. 1 shows a structure of a main part of a broadcast data transmission/reception system 100 of the embodiment.

A broadcast data transmission/reception system 100 includes a transmitter 700, a receiver 800, and a receiver 1600. Only one transmitter 700, one receiver 800, and one receiver 1600 are described in FIG. 1 for simplification. However, the number of each device is not limited to one, but may be plural.

The broadcast data transmission/reception system 100 includes hardware, such as a CPU, a ROM, a RAM, a hard disk, a decoder, and a filter. The RAM or the hard disk stores computer programs, and the system realizes its function by the CPU performing in accordance with the computer programs.

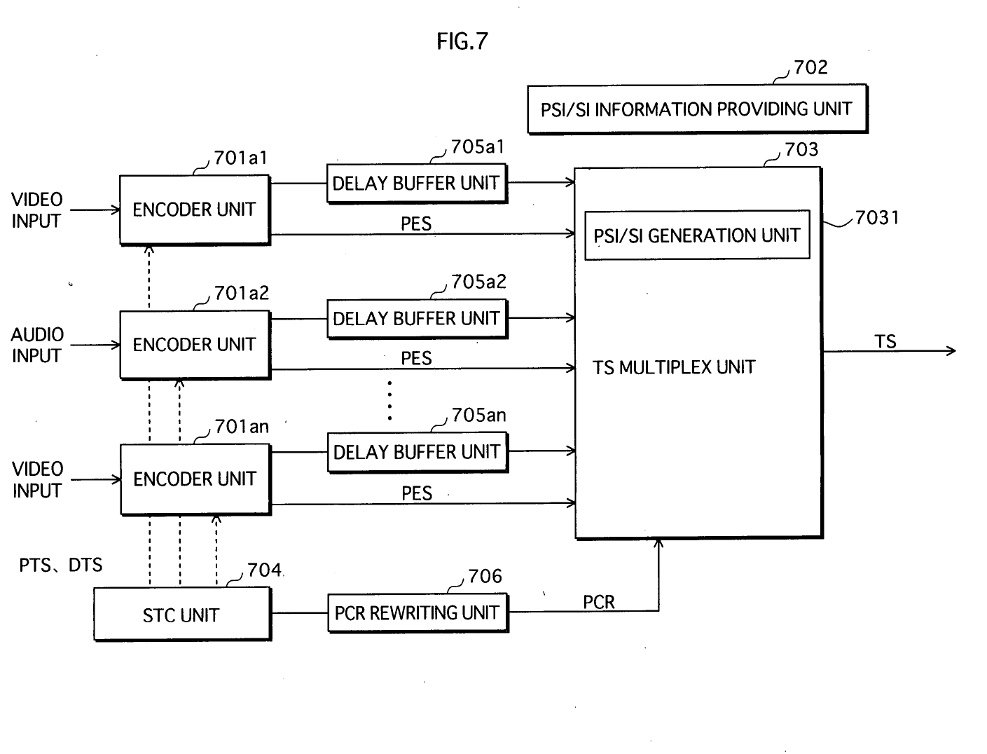

FIG. 7 is a functional block diagram showing the structure of a main part of the transmitter 700. The transmitter 700 includes encoder units 701a₁ to 701aₙ, a PSI/SI providing unit 702, a TS multiplex unit 703, a STC (System Time Clock) unit 704, delay buffer units 705a₁ to 705aₙ, and a PCR rewriting unit 706.

Each of the encoder units 701a₁ to 701aₙ encodes various broadcast data to generate PES packets, and outputs the generated PES packets to the TS multiplex unit 703 and corresponding one of the delay buffer units 705a₁ to 705aₙ. Each encoder unit encodes corresponding broadcast data that is previously associated with the encoder. For instance, the encoder unit 701a₁ encodes video data, and the encoder unit 701 a₂ encodes audio data.

Among the PES packets which are generated by the same encoder unit and include the same content, a PES packet directly output to the TS multiplex unit is hereinafter called a “preceding PES packet”, and a PES packet output to the TS multiplex unit via a corresponding delay buffer unit is hereinafter called a “standard PES packet”.

In the process of generating a PES packet, each of the encoder units 701a₁ to 701aₙ generates a PTS and a DTS based on an STC received from the STC unit 704, which indicates a base time of the transmitter 700. Then, each of the encoder units 701a₁ to 701aₙ encodes the generated PTS and DTS, and adds the encoded PTS and DTS to both the preceding PES packet and the standard PES packet. By this operation, the pair of the same PTS and the same DTS is to be added to both the preceding PES packet and the standard packet.

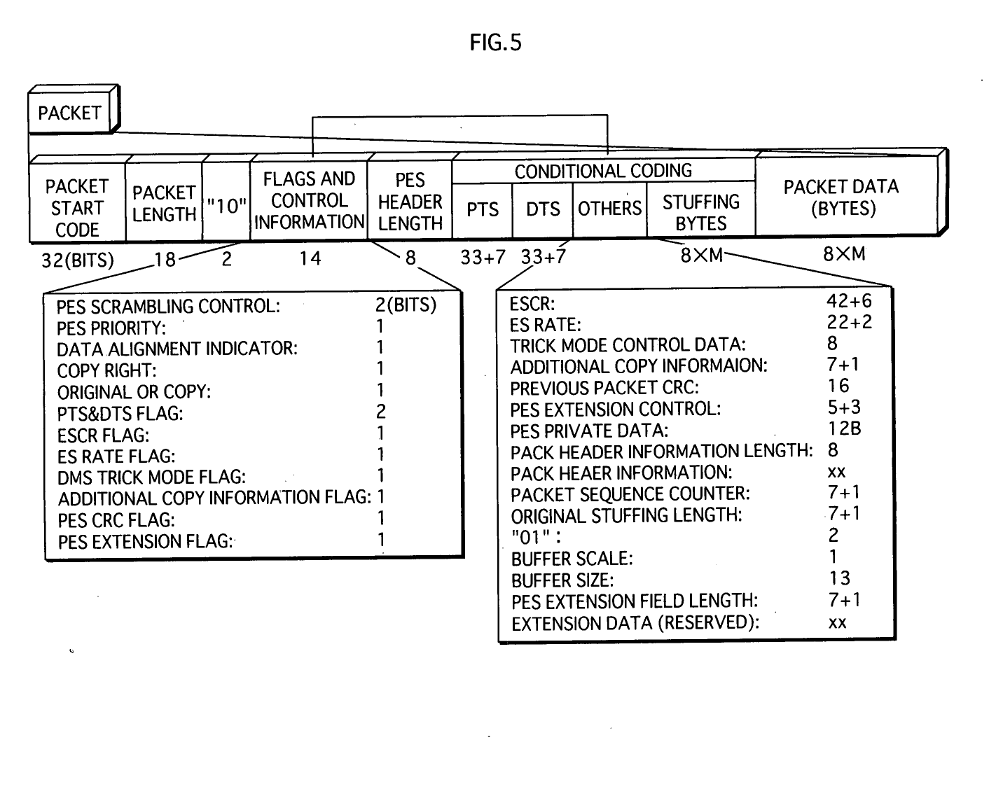

FIG. 5 shows a structure of a PES packet. The following describes a main part of the PES packet, with reference to FIG. 5. A PES header includes a packet start code, a packet length, a stream identifier represented by “10”, a header length, flags and control information, and control information such as conditional coding.

The packet start code is a code showing the start position of the PES packet. The packet length shows the number of bytes included in the PES packet. The stream identifier shows the type of the elementary stream. The header length shows the number of bytes included in the header of the PES packet. The conditional coding includes time stamp information indicating a reproduction start time of data inserted into the PES payload. This time stamp information includes two time stamps, namely the PTS and the DTS.

The PSI/SI providing unit 702 outputs source information for generating the PSI and the SI to the TS multiplex unit 703.

The STC unit 704 generates and outputs the STC to each of the encoder units 701a₁ to 701aₙ, and generates and outputs the PCR to the PCR rewriting unit 706 at predetermined intervals.

The TS multiplex unit 703 includes a PSI/SI generation unit 7031. The TS multiplex unit 703 divides each preceding PES packet received from the encoder units 701a₁ to 701aₙ into TS packets, and adds the same PID to each TS packet. Further, the TS multiplex unit 703 divides an RIT (Resending Information Table) generated by the PSI/SI information generation unit 7031 into TS packets, and transmits the TS packets by time division multiplexing.

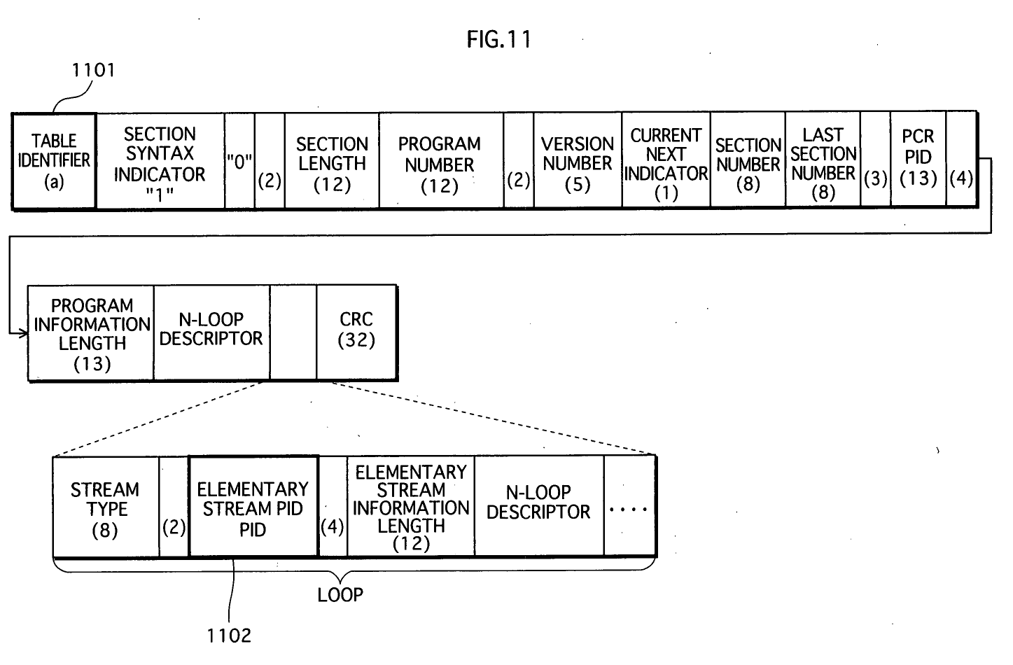

Here, the “RIT” is a table that contains descriptions of the PIDs of TS packets included in the elementary stream to which the preceding PES packets belong (These PIDs are hereinafter called “preceding packet PIDs”.). The RIT contains descriptions of the preceding packet PIDs of TS packets included in the elementary stream of various data constituting the same broadcast program. FIG. 11 shows the data structure of the RIT. The data structure of the RIT is similar to the data structure of the PMT, and only the content of the parts within heavy-line frames 1101 and 1102, namely the table identifier and the elementary stream PID, are different from those of the PMT.

More specifically, a different identifier from the identifier given to the PMT is described in the table identifier of the RIT, and the preceding packet PID is described as the elementary stream PID.

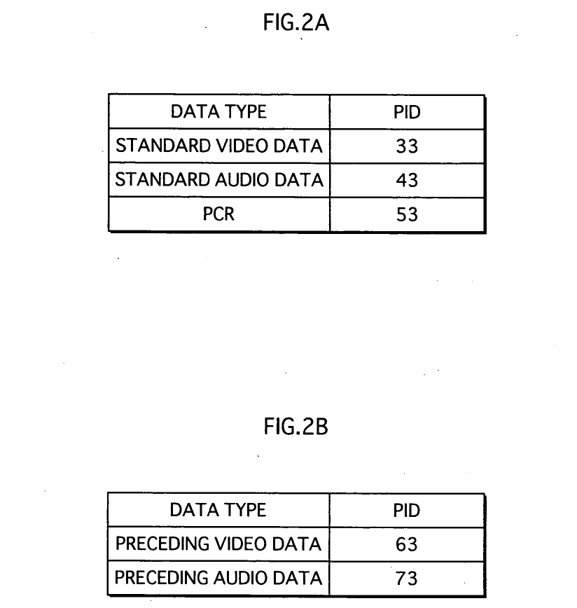

FIG. 2B is a specific example showing the preceding packet PID described in the RIT.

The TS multiplex unit 703 divides the standard PES packets, which are respectively corresponding to the preceding PES packets received from the delay buffer units into TS packets, and also divides the PSI and SI generated by the PSI/SI generation unit 7031 and the rewritten PCR received from the PCR rewriting unit 706 into the TS packets. Then, the TS multiplex unit 703 transmits the TS packets by time division multiplexing.

Here, the PMT transmitted as the PSI contains descriptions of the PIDs of TS packets included in the elementary stream to which the standard PES packets belong (these PIDs are hereinafter called “standard packet PIDs”), and of the PID of the TS packet for carrying the rewritten PCR (this PID is called a “rewritten PCR packet”).

FIG. 2A is a specific example of the standard packet PIDs and the content of the rewritten PCR, which are described in the PMT.

The PSI/SI generation unit 7031 generates the PSI, the SI and the RIT based on the PMT source information for generating the PSI and the SI received from the PSI/SI providing unit 702.

The STC unit 704 generates and outputs the STC to each of the encoder units 701a₁ to 701aₙ, and generates and outputs the PCR (Program Clock Reference) to the PCR rewriting unit 706 at predetermined intervals.

The delay buffer units 705a₁ to 705aₙ temporally store standard PES packets received from the encoder unit 701a₁ to 701aₙ respectively for a predetermined period, and output the standard PES packets to the TS multiplex unit 703.

Note that the same period is set to all the delay buffer units as the above-described predetermined period. This predetermined period is hereinafter called a delay period.

The PCR rewriting unit 706 rewrites each PCR, which is received from the STC unit 704, so that the PCR indicates a time the delay period subsequent to the original time. By this operation, the time indicated by the PCR becomes the same as the base time based on which the PTS and the DTS of the standard PES packets are determined.

Also, the transmitter 700 makes it possible to send the same broadcast data a plurality of times at predetermined intervals.

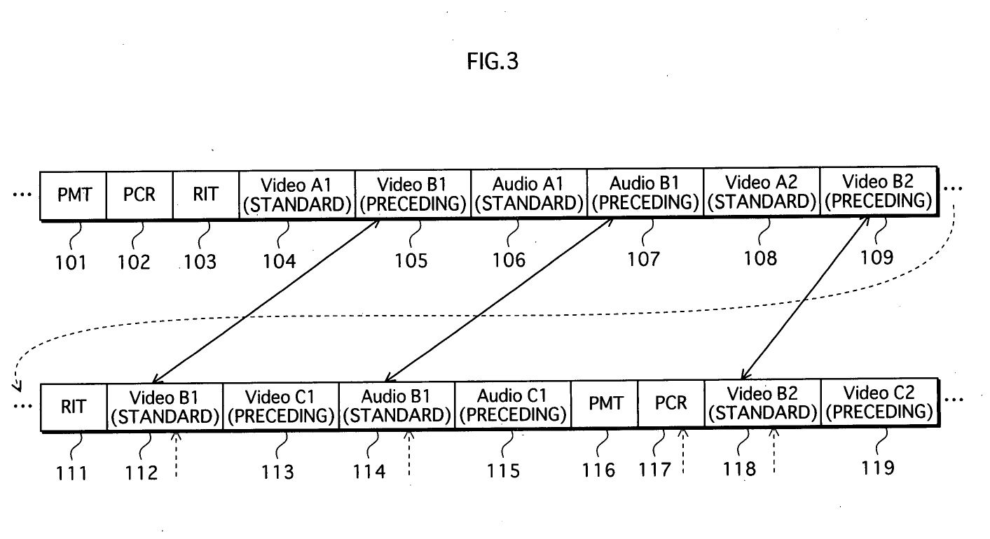

FIG. 3 schematically shows a specific example of the TS transmitted from the transmitter 700. The TS packets included in the TS is transmitted in the order of 101 to 119. Each of the signs 101 and 116 represents a TS packet including the PMT. Each of the signs 103 and 111 represents a TS packet including the RIT. Each of the signs 102 and 117 represents a TS packet including the PCR. Each of the signs 105, 109, 113, and 119 represents a preceding TS packet for video data. The sign 107 represents a preceding TS packet for audio data. Each of the sign 104, 108, 112 and 118 represents a standard TS packet for video data. Each of the signs 106 and 114 represents a standard TS packet for audio data.

Here, the “preceding TS packet” means a TS packet constituting a preceding PES packet, and the “standard TS packet” means a TS packet constituting a standard PES packet.

Each pair of TS packets connected by an arrow in FIG. 3 represents a pair of the preceding TS packet and its corresponding standard TS packet which include the same content.

The RIT in FIG. 3 contains descriptions of the PID of the preceding TS packet for video data and of the PID of the preceding TS packet for audio data. The PMT contains descriptions of the PID of the standard TS packet for video data, the PID of the standard TS packet for audio data, and the PID of the TS packet including the PCR.

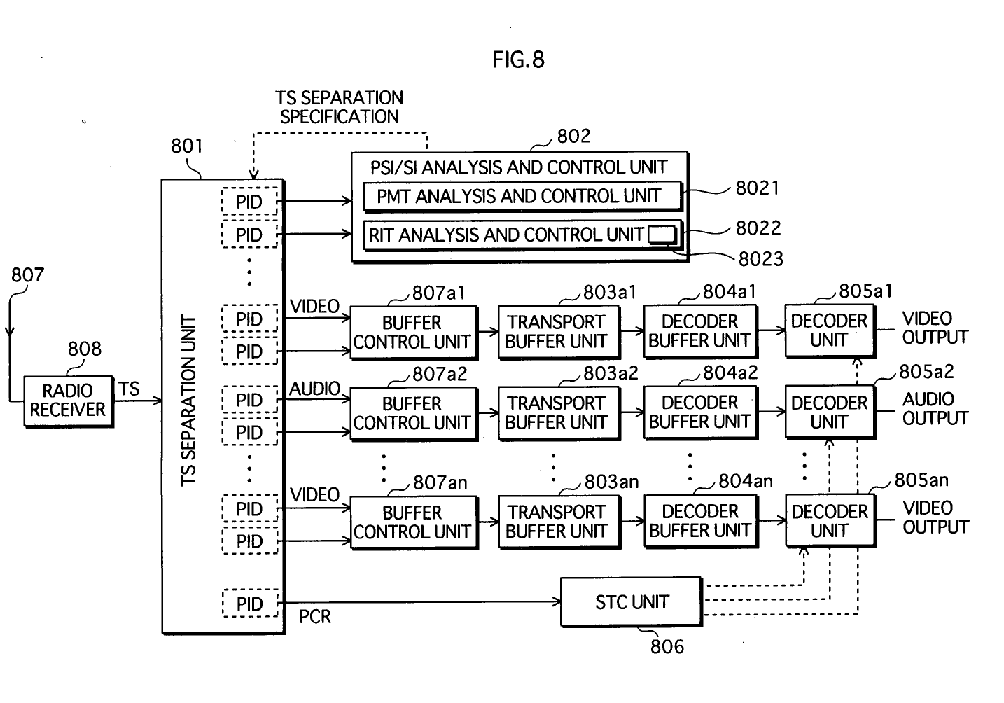

FIG. 8 is a functional block diagram showing the structure of the main part of the receiver 800. The receiver 800 includes a TS separation unit 801, a PSI/SI analysis and control unit 802, transport buffer units 803a₁ to 803aₙ, decoder buffer units 804a₁ to 804aₙ, decoder units 805a₁ to 805aₙ, and a STC unit 806.

When a radio receiver 808 starts receiving the TS transmitted from transmitter 700 via an antenna 807, the TS separation unit 801 receives a specification of the PID of a TS packet including an RIT (hereinafter called a “RIT packet”) from the PSI/SI analysis and control unit 802. Then the TS separation unit 801 separates the RIT packet having the specified PID from the received TS, and outputs the separated RIT packet to the PSI/SI analysis and control unit 802.

Also, the TS separation unit 801 separates a TS packet including a PSI (more specifically a TS packet including a PAT) from the received TS, and outputs the separated TS packet to the PSI/SI analysis and control unit 802.

Further, receiving specifications of the PIDs of preceding TS packets that are determined as packets that should be separated, based on the analysis result of the RIT from the PSI/SI analysis and control unit 802, the TS separation unit 801 separates the preceding TS packets having the specified PIDs from the received TS packets, and outputs each separated preceding TS packet to one of the buffer control units corresponding to the PID of the preceding TS packet.

Also, receiving a specification of the PID of a PMT packet based on the analysis result of the PAT included in the PAT packet from the PSI/SI analysis and control unit 802, the TS separation unit 801 separates the PMT packet having the specified PID from the received TS packet, and outputs the separated PMT packet to the PSI/SI analysis and control unit 802.

Further, receiving specifications of the PID of a rewritten PCR packet and the PIDs of standard TS packets constituting a broadcast program of the broadcast channel specified by the user via the input unit (not illustrated), the TS separation unit 801 separates the standard TS packet and the rewritten PCR packet respectively having the specified PIDs from the received TS. Then, the TS separation unit 801 outputs the separated standard TS packet to one of the buffer units corresponding to the PID of the standard TS packet, and outputs the separated rewritten packet to the STC unit 806.

The PSI/SI analysis and control unit 802 includes a PMT analysis and control unit 8021 and an RIT analysis and control unit 8022, and performs separated TS packet specification processing, which is described next.

The PSI/SI analysis and control unit 802 refers to a PAT included in a TS packet including PSI, which are received from the TS separation unit 801. Then the PSI/SI analysis and control unit 802 identifies the PID of a PMT corresponding to the broadcast program of the specified broadcast channel via the input unit (not illustrated), and transmits a specification of the identified PID to the TS separation unit 801 as the PID of the PMT which should be separated.

The PMT analysis and control unit 8021 refers to the description in the PMT of the PMT packet received from the TS separation unit 801. Then, the PMT analysis and control unit 8021 identifies the PIDs of the standard TS packets that carry the broadcast data constituting the broadcast program of the broadcast channel specified by the user and the rewritten packet, and transmits specifications of the identified PIDs to the TS separation unit 801 as the PIDs of TS packets that should be separated.

The RIT analysis and control unit 8022 includes a storing unit 8023. When the radio reception unit 808 starts receiving a TS corresponding to a broadcast channel, based on the specification of the broadcast channel received from the input unit (not illustrated), the RIT analysis and control unit 8022 reads out the PID of the RIT packet pre-stored in the storing unit 8023, and transmits a specification of the read-out PID to the TS separation unit 801 as the PID that should be separated.

Also, the RIT analysis and control unit 8022 refers to the description in the RIT of the RIT packet received from the TS separation unit 801, identifies the PIDs of the preceding TS packets including the broadcast data constituting the broadcast program of the specified broadcast channel, and transmits specifications of the identified PIDs to the TS separation unit 801 as the PIDs of the preceding TS packets that should be separated.

Each of the transport buffer units 803a₁ to 803aₙ stores the preceding or standard PES packets, which are received from the corresponding one of the buffer control unit 803a₁ to 803aₙ, in units of a few (one or more) PES packets. Then, each outputs the stored PES packets to the corresponding decoder buffer unit at predetermined intervals.

Each of the decoder buffer units 804a₁ to 804aₙ stores the preceding or standard PES packets received from the corresponding transport buffer unit.

The STC unit 806 adjusts, based on the base time indicated by the rewritten PCR of the rewritten PCR packet received from the TS separation unit 801, the STC of the receiver 800 so as to synchronize with a time the delay period after the time indicated by the STC of the transmitter 700. Then, the STC unit 806 outputs the adjusted STC to the decoder unit 805a₁ to 805aₙ.

Each of the decoder unit 805a₁ to 805aₙ compares the time indicated by the adjusted STC to the time indicated by the PTS and the DTS included in the PES packets stored in corresponding one of the buffer units 804a₁ to 804aₙ. Then, each decoder unit reads out the PES packets from the corresponding decoder buffer, and decodes and reproduces the PES packets when the time indicated by the adjusted STC becomes the times indicated by the DTS and the PTS respectively.

The buffer control units 807a₁ to 807aₙ includes buffers (not illustrated) respectively, and each performs PES packet output control processing, which is described next.

Each of the buffer control units 807a₁ to 807aₙ stores, in the buffer, preceding or standard TS packets respectively having the PIDs received from the TS separation unit 801, in units of a few (one or more) PES packets. The buffer control unit obtains packet length described in the header of each PES packet, and compares the number of bytes indicated by the packet length to the number of bytes included in the stored PES packet. When the number of bytes of the stored PES packet is less than the number of bytes indicated by the packet length, the buffer control unit judges that the PES packet suffers a partial loss, and discards the PES packet. When the number of bytes included in the stored PES packet is not less than the number of bytes indicated by the packet length, the buffer control unit judges whether the same PES packet as the stored PES packet is already stored in the corresponding transport buffer unit, by judging whether or not a PES packet whose header includes the PTS indicating the same time as the PTS included in the header of the stored PES packet exists. When such PES packet exists, the buffer control unit does not output the stored PES packet to the transport buffer unit, and when such PES packet does not exist, the buffer control unit outputs the stored PES packet to the transport buffer unit.

With this operation, the buffer control units 807a₁ to 807aₙ can detect a PES packet in which a TS packet constituting the PES packet suffers a partial loss, and stop outputting such TS packet. At the same time, the buffer control units 807a₁ to 807aₙ can stop the transport buffer units from storing duplicate PES packets.

The structure of the receiver 1600 is described in the Background Art. Therefore, it is not to be described here.

Operations

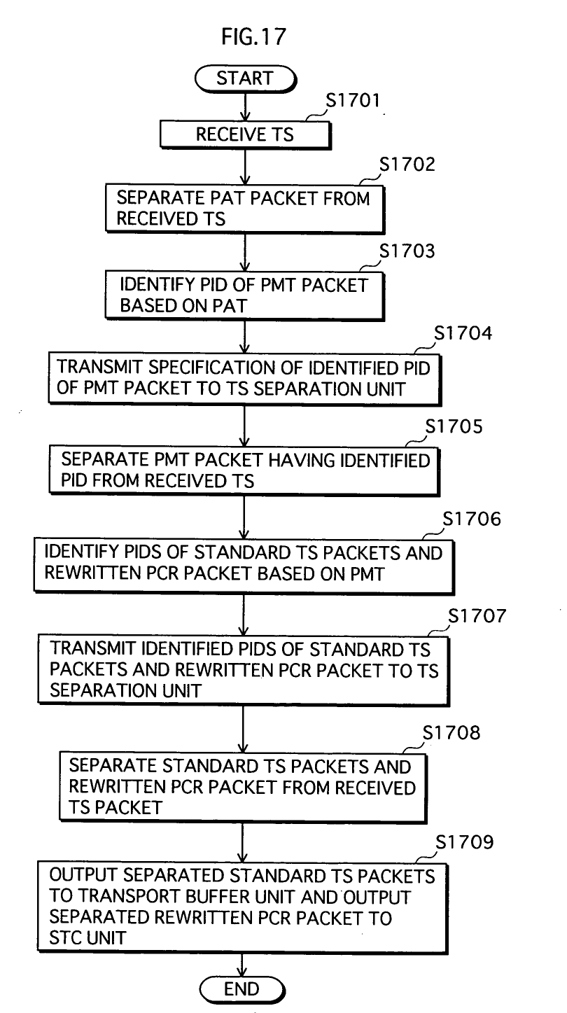

The TS packet separation processing operated by the receiver 1600 is described next. FIG. 17 is a flowchart showing this processing.

Via the antenna 1607, the radio reception unit 1608 receives a TS that is transmitted from the transmitter 700 (step S1701).

The TS separation unit 1601 separates a PAT packet from the received TS (step S1702), and outputs the separated PAT packet to the PSI/SI analysis and control unit 1602.

The PSI/SI analysis and control unit 1602 refers to the PAT included in the PAT packet input by the TS separation unit 1601, identifies the PID of the PMT packet corresponding to the broadcast channel specified by the user via the input unit (step S1703), and transmits a specification of the identified PID to the TS separation unit 1601 as the PID of the PMT packet that should be separated (step S1704).

Receiving the specification of the PID of the PMT packet from the PSI/SI analysis and control unit 1602, the TS separation unit 1602 separates the PMT packet having the specified PID from the received TS (step S1705), and outputs the separated PMT packet to the PSI/SI analysis and control unit 1602.

The PSI/SI analysis and control unit 1602 refers to the description of the PMT included in the PMT packet, identifies the PIDs of the standard packets and the rewritten PCR packet (step S1706), and transmits specifications of the identified PIDS of the standard packets and the rewritten PCR packet to the TS separation unit 1601 as the PIDs of the TS packets that should be separated (step S1707).

Receiving the specifications of the PIDs of the standard TS packets and the rewritten PCR packet from the PSI/SI analysis and control unit 1602, the TS separation unit 1601 separates the standard TS packets and the rewritten PCR packet respectively having the specified PIDs from the received TS (step S1708), outputs the separated TS packets to the corresponding transport buffer unit, and outputs the separated rewritten packet to the STC unit 806 (step S1709).

By these operations, in the case of receiving the TS including the preceding and standard TS packets transmitted from the transmitter 700, the receiver 1600 can perform the TS packet separation processing without problems as well as in the case where the receiver 1600 receives the TS not including the preceding TS packets.

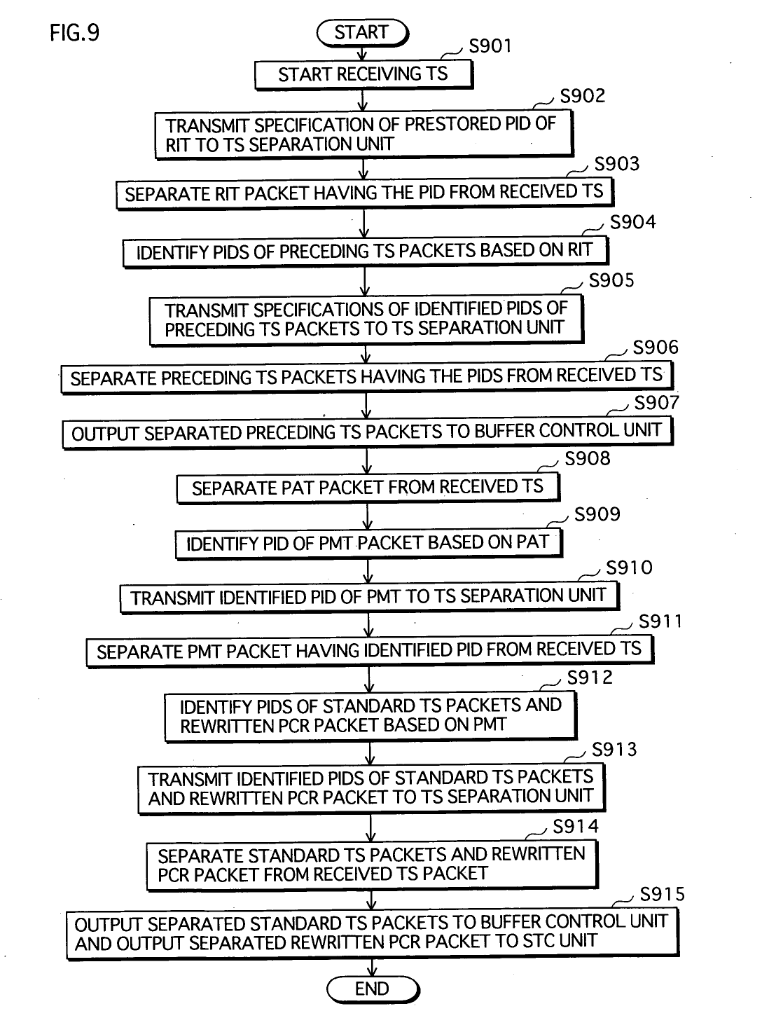

The TS packet separation processing performed by the receiver 800 is described next. FIG. 9 is a flowchart showing this processing.

When the radio receiver unit 808 starts receiving, via the antenna 807, the TS that is transmitted from the transmitter 700 (step S901), the RIT analysis and control unit 8022 reads out the PID of the RIT packet prestored in the storing unit 8023, and transmits a specification of the read-out PID to the TS separation unit 801 as the PID of the TS packet that should be separated (step S902).

The TS separation unit 801 receives the specification of the PID from the PSI/SI analysis and control unit 802, separates the RIT packet having the specified PID (step S903), and outputs the separated RIT packet to the PSI/SI analysis and control unit 802.

The RIT analysis and control unit 8022 refers to the description of the RIT included in the RIT packet received from the TS separation unit 801, identifies the PIDs of the preceding TS packets including broadcast data constituting the specified broadcast channel (step S904), and transmits specifications of the identified PIDs to the TS separation unit 801 as the PIDs of the preceding TS packets that should be separated (step S905).

Receiving the specifications of the PIDs of the preceding TS packets that should be separated, from the RIT analysis and control unit 8022, the TS separation unit 801 separates the preceding TS packets having the specified PIDs from the received TS (step S906), and outputs the separated preceding TS packets to the buffer control unit corresponding to the PIDs (step S907).

The TS separation unit 801 further separates the PAT packet from the received TS (step S908), and outputs the separated PAT packet to the PSI/SI analysis and control unit 802.

The PSI/SI analysis and control unit 802 identifies the PID of the PMT packet corresponding to the specified broadcast channel, based on the PAT included in the PAT packet received from the TS separation unit 801 (steps S909), and transmits a specification of the identified PID to the TS separation unit 801 as the PID of the PMT packet that should be separated (step S910).

Receiving the specification of the PID of the PMT packet from the PSI/SI analysis and control unit 802, the TS separation unit 801 separates the PMT packet having the specified PID from the received TS (step S911), and outputs the separated PMT packet to the PSI/SI analysis and control unit 802.

The PMT analysis and control unit 8021 refers to the description of the PMT included in the PMT packet received from the TS separation unit 801, identifies the PIDs of the standard TS packets that carry the broadcast data constituting the broadcast program of the broadcast channel specified by the user and the PID of the rewritten PCR packet (step S912), and transmits specifications of the identified PIDs to the TS separation unit 801 as the PIDs of the TS packets that should be separated (step S913).

Receiving the specifications of PIDs of the standard TS packets and the rewritten PCR packet from the PMT analysis and control unit 8021, the TS separation unit 1601 separates the standard TS packets and the rewritten PCR packet respectively having the specified PIDs from the received TS (step S914), outputs the separated standard TS packets to the buffer control units respectively corresponding to the PIDs, and outputs the separated rewritten packet to the STC unit 806 (step S915).

With these operations, the receiver 800 can obtain both preceding and standard TS packets from a TS being transmitted from the transmitter 700 and including the preceding and standard TS packets unlike in the case of the receiver 1600.

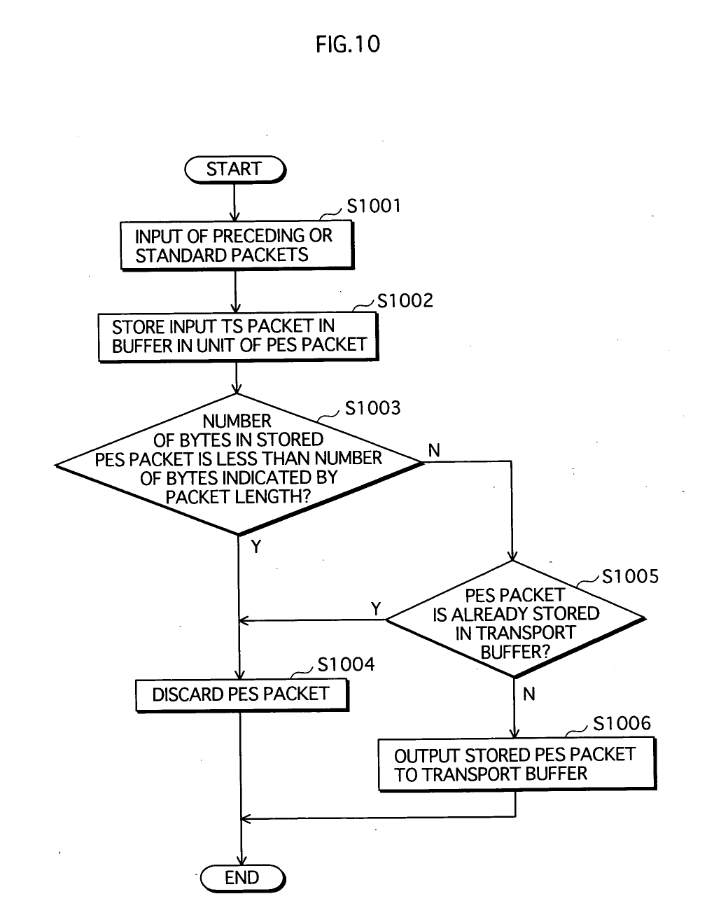

The PES packet output control processing performed by the buffer control units 807a₁ to 807aₙ is described next. FIG. 10 is a flowchart showing this processing.

When receiving preceding or standard TS packets from the TS separation unit 801 (step S1001), each of the buffer control units 807a₁ to 807aₙ stores the received TS packets in units of a few PES packets (step S1002), and judges whether or not the number of bytes included in each PES packet is less than the number of bytes indicated by the packet length which is described in the header of the PES packet (step S1003).

When the number of bytes included in the PES packet is less than the number of bytes indicated by the packet length (step S1003: Y), the buffer control unit judges that the PES packet suffers a partial loss, and discards the PES packet (step S1004).

When the number of bytes included in the PES packet is not less than the number of bytes indicated by the packet length (step S1003: N), the buffer control unit judges that the PES packet does not suffer a loss, and judges whether or not the PES packet is already stored in the transport buffer unit corresponding to the buffer control unit, by judging whether or not a PES packet whose header includes a PTS indicating the same time as the PTS included in the header of the stored PES packet indicates (step S1005).

When the PES packet is already stored in the corresponding transport buffer (step S1005: Y), the buffer control unit discards the PES packet (step S1004).

When the PES packet is not stored in the corresponding transport buffer (step S1005: N), the buffer control unit outputs the PES packet to the corresponding transport buffer (step S1006).

### SPECIFIC EXAMPLE

The following describes a specific example showing how broadcast data which is lost in the middle of transmission is effectively recovered in the broadcast data transmission/reception system 100.

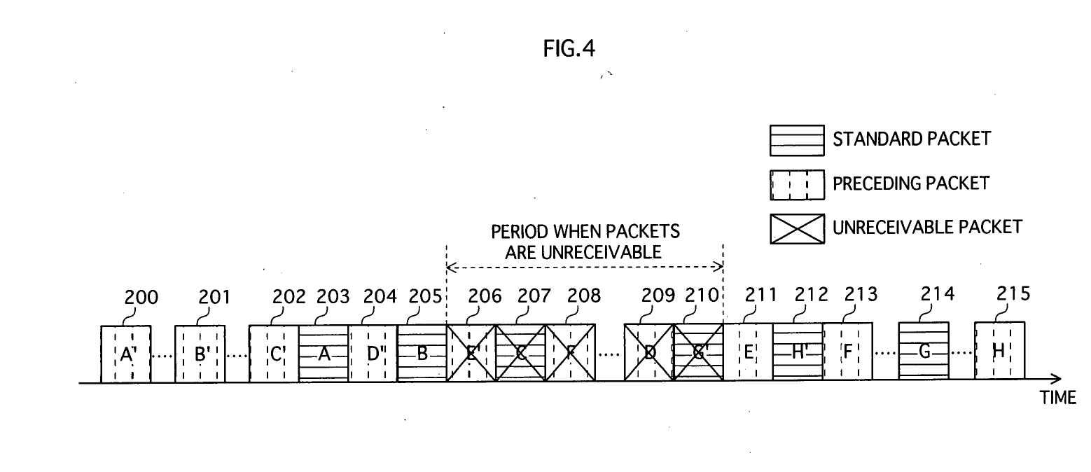

FIG. 4 shows a specific example of a TS that is transmitted from the transmitter 700 in the case where the TS packets included in the TS are partially lost in the middle of the transmission.

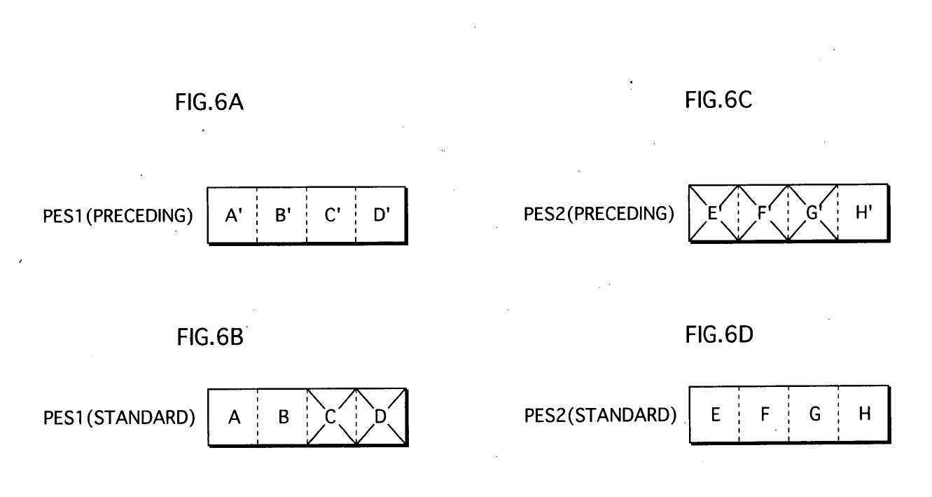

Each box with vertical broken lines represents a TS packet included in a preceding PES packet (hereinafter called a “preceding TS packet”). Each box with horizontal lines represents a TS packet included in a standard PES packet (hereinafter called a “standard TS packet”) Each box with a cross represents a TS packet which is lost in the middle of transmission and can not be received, because of bad weather and so on. The preceding TS packets represented by signs A′ to D′ and the standard TS packets represented by signs A to D in FIG. 4 respectively constitute PES packets having the same content, namely “PES1” as FIG. 6A and FIG. 6B show. The preceding TS packets represented by signs E′ to H′ and the standard TS packets represented by signs E to H in FIG. 4 respectively constitute PES packets having the same content, namely “PES2” as FIG. 6C and FIG. 6D show.

As described above, the preceding PES packets without any loss (PES1) shown in FIG. 6A are to be stored and reproduced by the receiver 800. Therefore, even in the case where the standard PES packets shown in FIG. 6B (PES1) having the same content as the preceding PES packets suffer a loss, the PES1 is to be reproduced completely.

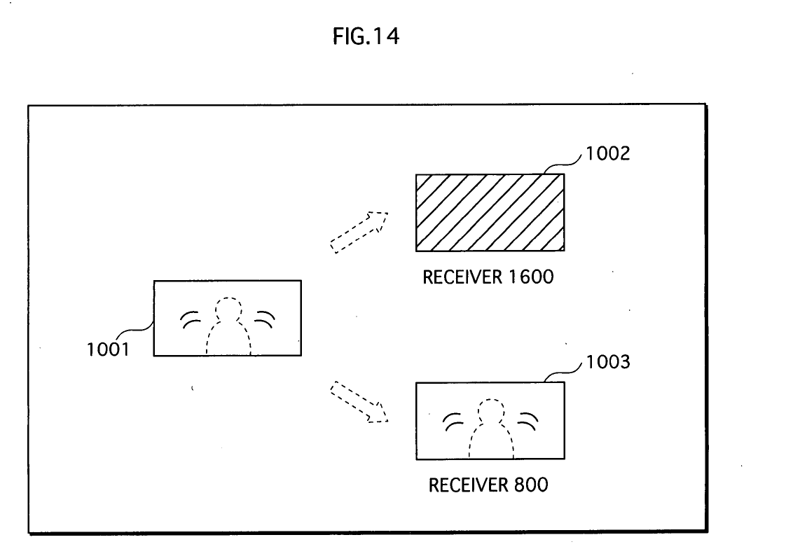

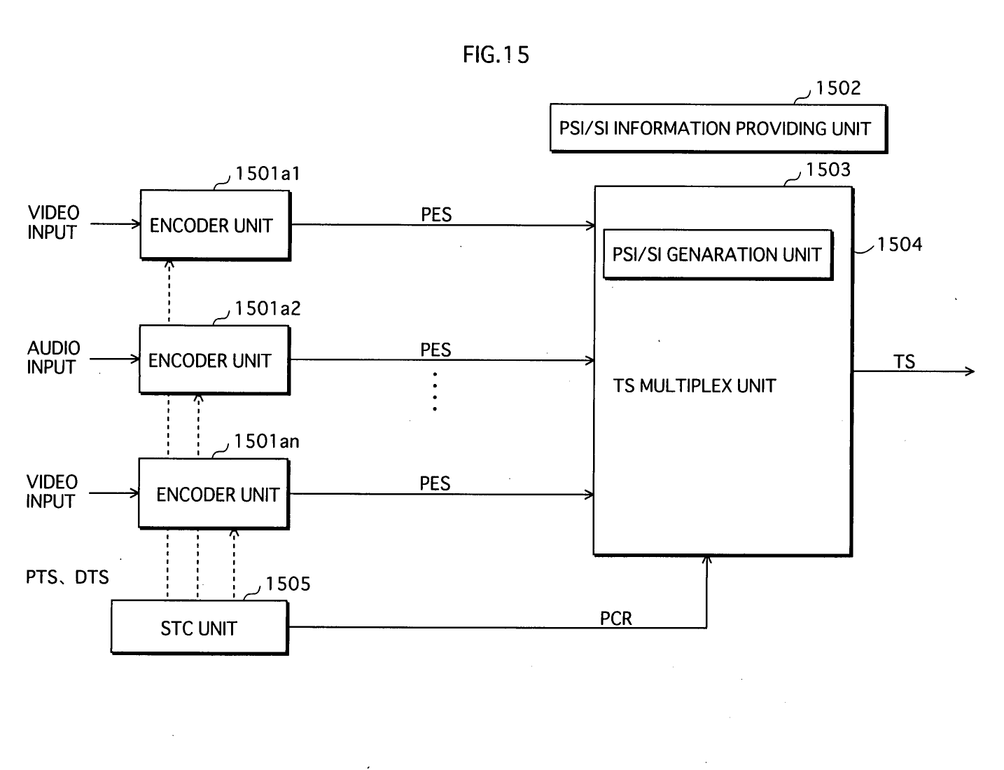

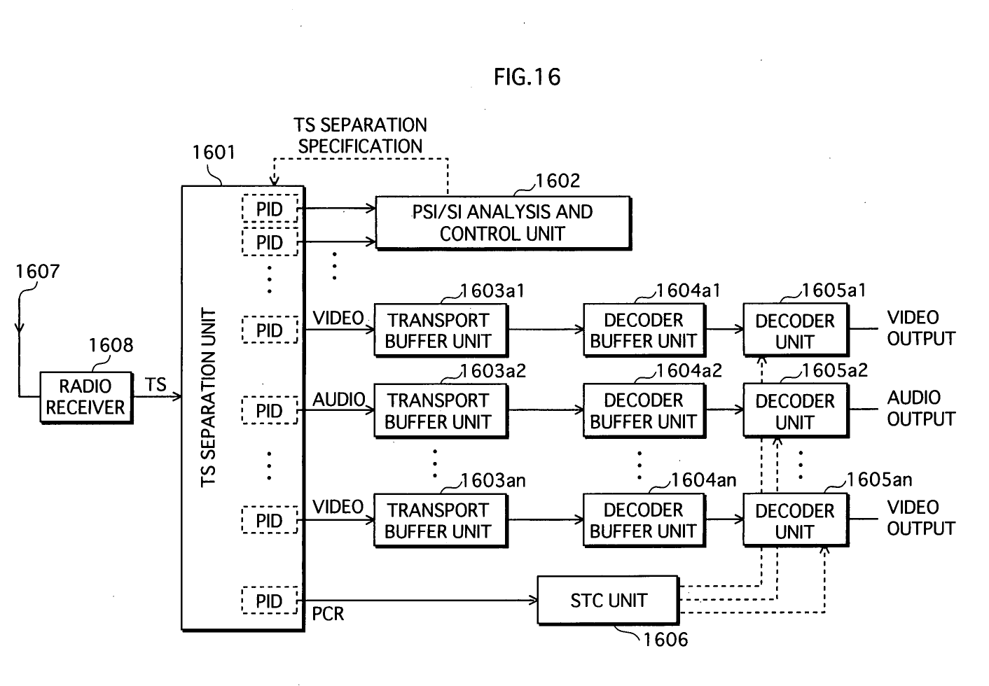

FIG. 14 shows an image displayed in the case where the PES1 is received and reproduced by the receiver 800 and an image displayed in the case where the PES1 is received and reproduced by the receiver 1600. Here, it is assumed that the PES1 is image data constituting one frame image. An image 1001 in FIG. 14 is reproduced in the case where there is no lost TS packet. An image 1002 is reproduced by the receiver 1600. An image 1003 is reproduced by the receiver 800.

In the same way, the standard PES packets without any loss (PES2) shown in FIG. 6D are to be stored and reproduced by the receiver 800. Therefore, even in the case where the preceding packets shown in FIG. 6C (PES2) having the same content as the standard PES packets suffer a loss, the PES2 is to be reproduced completely.

As described above, by transmitting PES packets having the same content, as the preceding TS packets and the standard PES packets a plurality of times at intervals, complete video data and audio data can be reproduced even if either type of those PES packets are lost in the middle of the transmission.

Supplemental Description

The broadcast data transmission/reception system 100 pertaining to the present invention is described above. Note that the present invention is not limited to the above-described embodiment, as a matter of course. More specifically:

(1) In the broadcast data transmission/reception system 100 of the present invention, pieces of broadcast data having the same content is transmitted a plurality of times at intervals. However, instead of transmitting pieces of broadcast data having the same content a plurality of times, the broadcast data transmission/reception system 100 may transmit pieces of broadcast data that are in complementary relation to each other, and based on which similar images can be restored.

More specifically, the broadcast data transmission/reception system 100 may encode, to generate PES packets, image data included in odd-numbered fields and even-numbered fields of frame images which are sequential in terms of time, such as frame images displayed by interlaced scanning. The transmission/reception system 100 may transmit the PES packets generated from the odd-numbered fields or, alternatively, the PES packets generated from the even-numbered fields as the preceding PES packets, and transmit the rest as the standard PES packets.

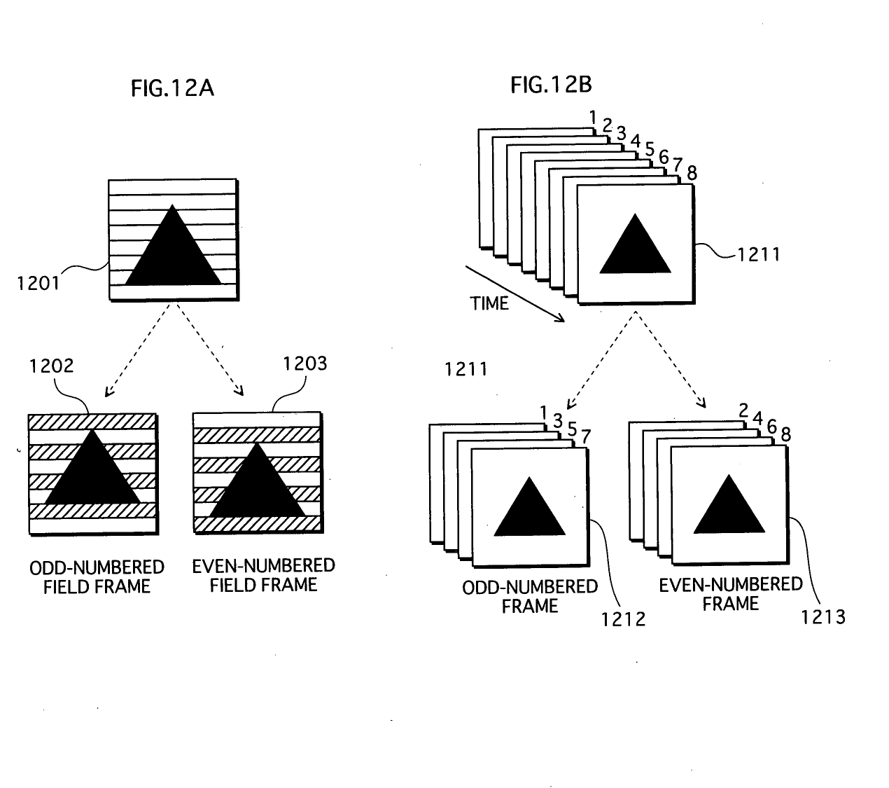

FIG. 12A shows a specific example of frame images constituting a moving picture displayed by interlaced scanning. An image 1201 in FIG. 12A represents a frame image which is a combination of images respectively constituted of the odd-numbered fields and the even-numbered fields. Shaded areas 1202 represent the frame image constituted of the odd-numbered fields, and shaded areas 1203 represent the frame image constituted of the even-numbered fields. As the areas 1202 and 1203 in FIG. 12A show, a frame image that closely resembles the complete frame image 1201 can be reproduced based only on either of the image data, namely the image data constituted of the odd-numbered fields or the image data constituted of the even-numbered fields.

Also, the transmission/reception system 100 may divide each of a plurality of frame images, which are sequential in terms of time and constitutes a moving picture displayed by progressive scanning without partitioning the frame image, into odd-numbered frame images and even-numbered frame images. The transmission/reception system 100 may encode the image data constituting odd-numbered frame image and image data constituting even-numbered frame image to generate PES packets for each, transmit the PES packets generated from the odd-numbered frame image or the even-numbered frame image as the preceding PES packets, and transmit the rest as the standard PES packets.

FIG. 12B shows a specific example of frame images constituting a moving picture displayed by progressive scanning. An image 1211 in FIG. 12B represents a frame image. Images 1211 in FIG. 12B represent frame images constituting a moving picture, which are sequential in terms of time. Images 1212 represent odd-numbered frame images extracted from the frame images 1211. Images 1213 represent even-numbered frame images extracted from the frame images 1211.

This modification can be realized by the following structure of the broadcast data transmission/reception system.

A transmitter of the modification is realized with the same structure as the transmitter 7000f the embodiment. However, note that the PTS and DTS which are to be added to the preceding PES packet are different from the PTS and DTS which are to be added to the standard PES packet.

Also, a receiver for receiving only standard packets is realized with the same structure as the receiver 1600 of the embodiment.

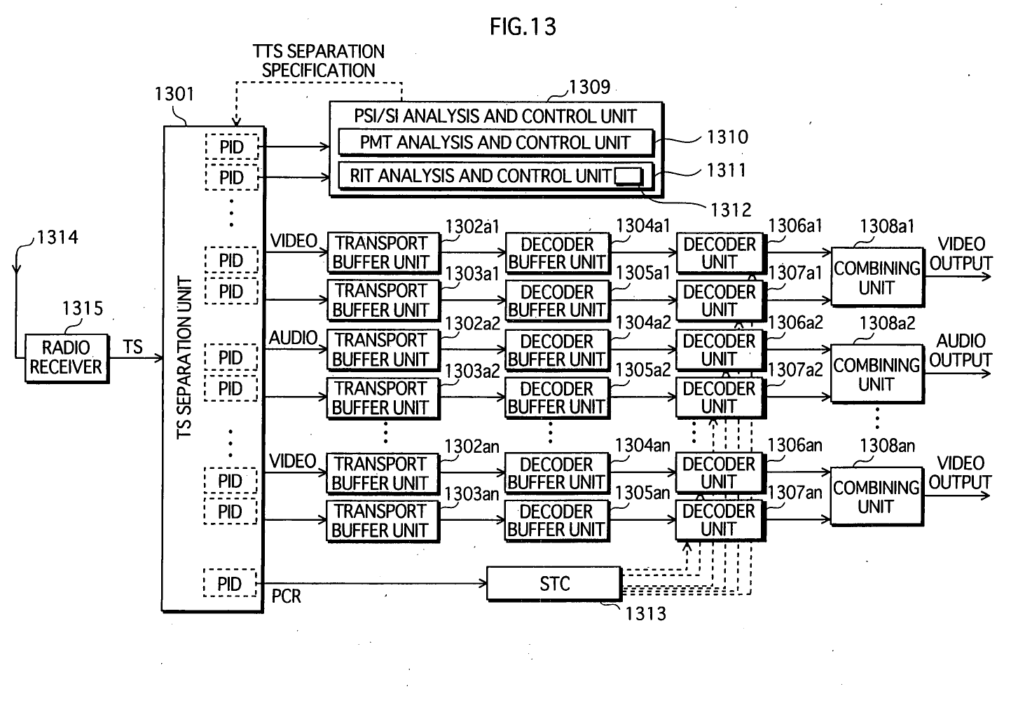

A receiver for receiving both preceding packets and standard packets is realized by a receiver 1300 shown in FIG. 13.

The following mainly describes the difference between the receiver 800 in the embodiment and the receiver 1300. In the receiver 800, the preceding TS packets and the standard TS packets separated by the TS separation unit 801 are output to the same buffer control unit. However, in the receiver 1300, they are to be stored, as PES packets, in the transport buffer units corresponding to their PIDs respectively. Further, these TS packets are to be output to each decoder buffer unit without being discarded. Then, at times indicated by the PTS and the DTS respectively, the PES packets are decoded and reproduced by each decoder unit. A combining unit combines video data included in the preceding PES packets and video data included in the standard PES packets together, converts the combined video data to video signals, and outputs the signals.

With these operations, even if the reception of the broadcast data becomes temporally impossible, the receiver 1300 can restore substantially the same images as the images based on the broadcast data, which was supposed to be carried by the unreceived broadcast wave, without transmitting duplicate broadcast data. This improves the efficiency of the data transmission. Further, the pieces of received video data in complementary relation are not to be discarded, but to be output after being combined. This provides images with higher quality.

In the same way, audio data may be divided into pieces of audio data in complementary relation to each other by moving sampling points, and transmitted as the preceding PES packets and the standard PES packets.

(2) Instead of pieces of broadcast data in complementary relation to each other as described in (1), the transmitter may transmit different pieces of broadcast data overlapping each other.

For instance, when transmitting a video data stream as broadcast data constituted of units of GOP (Group of Picture) including one I-picture and a plurality of B-pictures and P-pictures compressed by forward predictive encoding according to MPEG-2 standard and so on, the transmitter may transmit each GOP with use of the standard PES packets, and transmit the I-picture, which is included in each GOP and can be decoded and reproduced independently, with use of the preceding PES packets.

This reduces the number of TS packets required for transmitting the preceding PES packets, and thereby reduces the processing load of the transmitter. At the same time, this makes it possible to restore the main part of the video when the transmitted GOP is lost in the middle of the transmission.

This modification can be realized by the broadcast data transmission/reception system 100 of the embodiment. However, note that in the operation of the PES packet output control processing shown in FIG. 10, each of the buffer control units 807a₁ to 807aₙ of the modification does not perform the processing in step S1004 when it is judged in step S1005 that a PES packet whose PTS indicates the same time as the received PES packet is already stored in the transport buffer unit (step S1005: Y) In such case, instead of performing the processing, the buffer control units 807a₁ to 807aₙ discard the already stored PES packet, and output the PES packet stored in the buffer to the corresponding transport buffer unit. This operation is different from the embodiment.

This difference allows the receiver 800 to give priority to reproduction of video that is based on GOP when PES packets including GOP are not lost in the middle of transmission and received completely, because the corresponding I-picture stored in the transport buffer unit is to be replaced by the received GOP.

(3) In the embodiment, the preceding PES packets, which are transmitted before the standard PES packets are transmitted, are transmitted only once. However, the number of transmissions of the preceding PES packet is not limited to once, but may be a plurality of times.

(4) In the embodiment, the preceding PES packets and the standard PES packets are transmitted as to all types of broadcast data constituting broadcast programs. However, the preceding PES packets and the standard PES packets may be transmitted as to only a specific type of broadcast data (e.g. video data), and only the standard PES packets may be transmitted as to the other data.

(5) In the embodiment, the RIT has the data structure shown in FIG. 11. However, the RIT may have other data structure as long as the structure contains a description of the PID of the preceding PES packet.

(6) In the embodiment, the broadcast data and the TS are multiplexed to be transmitted. However, other packet multiplexing method that can control the reproduction start time of the broadcast data may be used.

(7) In the embodiment, the preceding TS packets and the standard TS packet transmitted from the transmitter 700 are received via the radio reception unit 808. However, the preceding TS packets and the standard TS packets may be received or transmitted via a cable line. Also, the preceding TS packets and the standard TS packets may be broadcasted not only by radio broadcasting but also by cable broadcasting, and may be transmitted to the receiver 800 via LAN or the Internet as well.

### INDUSTRIAL APPLICABILITY

The present invention is applicable to a broadcast data transmission/reception system with use of a transmission method in which a transmitter transmits substitutive broadcast data before transmitting broadcast data that should be reproduced at a time of actual telecast.

1. A broadcast data transmission/reception system that includes a transmitter, a first receiver and a second receiver, the transmitter transmitting broadcast data including time information indicating a reproduction start time, and both the first and second receivers trying to obtain the broadcast data, wherein
the transmitter further transmits, at least a predetermined amount of time prior to transmitting the broadcast data, substitutive broadcast data and a substitutive identifier one or more times, the substitutive broadcast data including a same content as the broadcast data and time information indicating the reproduction start time, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the reproduction start time, one of the broadcast data and the substitutive broadcast data if successfully obtained.

2. The broadcast data transmission/reception system according to claim 1, wherein
the broadcast data obtaining unit includes:
a recording medium; and
a recording subunit operable to record, on the recording medium, whichever of the substitutive broadcast data and the broadcast data is obtained first, and
the reproducing unit reproduces, at the reproduction start time, whichever of the substitutive broadcast data and the broadcast data is recorded on the recording medium.

3. The broadcast data transmission/reception system according to claim 2, wherein
each of the broadcast data and the substitutive broadcast data includes a plurality of data elements,
the broadcast data obtaining unit includes a judging subunit for judging whether the broadcast data or the substitutive broadcast data includes all the data elements, every time the broadcast data obtaining unit receives the broadcast data or the substitutive broadcast data, and
the broadcast data obtaining unit obtains the broadcast data or the substitutive broadcast data only when a judgment result by the judging subunit is affirmative.

4. The broadcast data transmission/reception system according to claim 1, wherein
the transmitter transmits pieces of the broadcast data having different reproduction start times respectively, and the transmitter further transmits, at least the predetermined amount of time prior to transmitting the pieces of the broadcast data, pieces of the substitutive broadcast data respectively corresponding to the pieces of the broadcast data one or more times, each piece of the substitutive broadcast data including a same content as a corresponding piece of the broadcast data and time information indicating a same reproduction start time as a reproduction start time of the corresponding piece of the broadcast data,
the broadcast data obtaining unit tries to obtain the piece of the substitutive broadcast data based on the substitutive identifier specified by the identifier specifier, and
the reproducing unit reproduces, at the reproduction start time, one of the piece of the broadcast data and the piece of the substitutive broadcast data if successfully obtained.

5. The broadcast data transmission/reception system according to claim 4, wherein
the broadcast data obtaining unit includes:
a recording medium;
a recording and judging subunit operable to record, on the recording medium, each piece of the substitutive broadcast data if successfully obtained, and judge whether a piece of the substitutive broadcast data having a same reproduction start time as a piece of the broadcast data is recorded on the recording medium; and
a recording control unit operable to record the piece of the broadcast data on the recording medium only when a judgment result by the recording and judging subunit is negative, and
the reproducing unit reproduces, at the reproduction start time, whichever of the piece of the broadcast data and the piece of the substitutive broadcast data is recorded on the recording medium.

6. The broadcast data transmission/reception system according to claim 5, wherein
each of the plural pieces of the broadcast data and the plural pieces of the substitutive broadcast data includes a plurality of data elements,
the broadcast data obtaining unit includes a judging subunit for judging whether the broadcast data or the substitutive broadcast data includes all the data elements, every time the broadcast data obtaining unit receives the broadcast data or the substitutive broadcast data, and
the broadcast data obtaining unit obtains the broadcast data or the substitutive broadcast data only when a judgment result by the judging subunit is affirmative.

7. A broadcast data transmission/reception system that includes a transmitter, a first receiver and a second receiver, the transmitter transmitting broadcast data including time information indicating a first reproduction start time, and both the first and second receivers trying to obtain the broadcast data, wherein
the broadcast data is a piece of still images that constitute a moving picture and have sequential reproduction start times respectively,
the transmitter further transmits, at least a predetermined amount of time prior to transmitting the broadcast data, substitutive broadcast data and a substitutive identifier one or more times, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the first reproduction start time, the broadcast data if successfully obtained, and reproduce, at the second reproduction start time, the substitutive broadcast data if successfully obtained.

8. A broadcast data transmission/reception system that includes a transmitter, a first receiver and a second receiver, the transmitter transmitting broadcast data including time information indicating a reproduction start time, and both the first and second receivers trying to obtain the broadcast data, wherein
the broadcast data includes a plurality of data elements,
the transmitter further transmits, at least a predetermined amount of time prior to transmitting the broadcast data, substitutive broadcast data and a substitutive identifier one or more times, the substitutive broadcast data including a predetermined member among the data elements and time information indicating the reproduction start time, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the reproduction start time, only the broadcast data if successfully obtained, and reproduce, at the reproduction start time, the substitutive broadcast data in a case where the broadcast data obtaining unit has failed to obtain the broadcast data and succeeded in obtaining the substitutive broadcast data.

9. The broadcast data transmission/reception system according to claim 8, wherein
the broadcast data constitutes a GOP (Group of Picture) encoded by MPEG (Moving Picture Expert Group) method, and the substitutive broadcast data constitutes an I-picture, which is a data element included in the GOP.

10. The broadcast data transmission/reception system according to claim 8, wherein
the broadcast data constitutes a GOP (Group of Picture) encoded by MPEG (Moving Picture Expert Group) method, and the substitutive broadcast data constitutes an I-picture and a P-picture, which are data elements included in the GOP.

11. A second receiver that tries to obtain broadcast data including time in formation indicating a reproduction start time, a first receiver trying to obtain the broadcast data, wherein
the second receiver further tries to obtain substitutive broadcast data and a substitutive identifier which are transmitted one or more times at least a predetermined amount of time prior to a time when the broadcast data is transmitted, the substitutive broadcast data including a same content as the broadcast data and time information indicating the reproduction start time, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the reproduction start time, one of the broadcast data and the substitutive broadcast data if successfully obtained.

12. The second receiver according to claim 11, wherein
the broadcast data obtaining unit includes:
a recording medium; and
a recording subunit operable to record, on the recording medium, whichever of the substitutive broadcast data and the broadcast data is obtained first, and
the reproducing unit reproduces, at the reproduction start time, whichever of the substitutive broadcast data and the broadcast data is recorded on the recording medium.

13. The second receiver according to claim 12, wherein
each of the broadcast data and the substitutive broadcast data includes a plurality of data elements,
the broadcast data obtaining unit includes a judging subunit for judging whether the broadcast data or the substitutive broadcast data includes all the data elements, every time the broadcast data obtaining unit receives the broadcast data or the substitutive broadcast data, and
the broadcast data obtaining unit obtains the broadcast data or the substitutive broadcast data only when a judgment result by the judging subunit is affirmative.

14. The second receiver according to claim 11, wherein
the second receiver receives pieces of the broadcast data having different reproduction start times respectively, and further receives pieces of the substitutive broadcast data corresponding to the pieces of the broadcast data respectively, each piece of the substitutive broadcast data being transmitted one or more times at least a predetermined amount of time prior to a time when the broadcast data is transmitted, and including a same content as a corresponding piece of the broadcast data and time information indicating a same reproduction start time as a reproduction start time of the corresponding piece of the broadcast data,
the broadcast data obtaining unit tries to obtain the piece of the substitutive broadcast data based on the substitutive identifier specified by the identifier specifier, and
the reproducing unit reproduces, at the reproduction start time, one of the piece of the broadcast data and the piece of the substitutive broadcast data if successfully obtained.

15. The second receiver according to claim 14, wherein
the broadcast data obtaining unit includes:
a recording medium;
a recording and judging subunit operable to record, on the recording medium, each piece of the substitutive broadcast data if successfully obtained, and judge whether a piece of the substitutive broadcast data having a same reproduction start time as a piece of the broadcast data is recorded on the recording medium; and
a recording control unit operable to record the piece of the broadcast data on the recording medium only when a judgment result by the recording and judging subunit is negative, and
the reproducing unit reproduces, at the reproduction start time, which ever of the piece of the broadcast data and the piece of the substitutive broadcast data is recorded on the recording medium.

16. The second receiver according to claim 15, wherein
each of the plural pieces of the broadcast data and the plural pieces of the substitutive broadcast data includes a plurality of data elements,
the broadcast data obtaining unit includes a judging subunit for judging whether the broadcast data or the substitutive broadcast data includes all the data elements, every time the broadcast data obtaining unit receives the broadcast data or the substitutive broadcast data, and
the broadcast data obtaining unit obtains the broadcast data or the substitutive broadcast data only when a judgment result by the judging subunit is affirmative.

17. A second receiver that tries to obtain broadcast data including time information indicating a reproduction start time, a first receiver trying to obtain the broadcast data, wherein
the broadcast data is a piece of still images that constitute a moving picture and have sequential reproduction start times respectively,
the second receiver further receives substitutive broadcast data and a substitutive identifier which are transmitted one or more times at least a predetermined amount of time prior to a time when the broadcast data is transmitted, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the first reproduction start time, the broadcast data if successfully obtained, and reproduce, at the second reproduction start time, the substitutive broadcast data if successfully obtained.

18. A second receiver that tries to obtain broadcast data including time information indicating a reproduction start time, a first receiver trying to obtain the broadcast data, wherein
the broadcast data includes a plurality of data elements,
the second receiver further receives substitutive broadcast data and a substitutive identifier which are transmitted one or more times at least a predetermined amount of time prior to a time when the broadcast data is transmitted, the substitutive broadcast data including a predetermined member among the data elements and time information indicating the reproduction start time, and the substitutive identifier being for identifying the substitutive broadcast data, and
the second receiver further includes:
a storing unit that stores therein an identifier specifier for specifying the substitutive identifier;
a broadcast data obtaining unit operable to try to obtain the substitutive broadcast data based on the substitutive identifier specified by the identifier specifier; and
a reproducing unit operable to reproduce, at the reproduction start time, only the broadcast data if successfully obtained, and reproduce, at the reproduction start time, the substitutive broadcast data in a case where the broadcast data obtaining unit has failed to obtain the broadcast data and succeeded in obtaining the substitutive broadcast data.

19. The second receiver according to claim 18, wherein
the broadcast data constitutes a GOP (Group of Picture) encoded by MPEG (Moving Picture Expert Group) method, and the substitutive broadcast data constitutes an I-picture, which is a data element included in the GOP.

20. The second receiver according to claim 18, wherein
the broadcast data constitutes a GOP (Group of Picture) encoded by MPEG (Moving Picture Expert Group) method, and the substitutive broadcast data constitutes an I-picture and a P-picture, which are data elements included in the GOP.

21. A transmitter, comprising:
a first transmission unit operable to transmit broadcast data including time information indicating a reproduction start time, both a first receiver and a second receiver trying to obtain the broadcast data; and
a second transmission unit operable to transmit, at least a predetermined amount of time prior to a time when the first transmission unit transmits the broadcast data, substitutive broadcast data and a substitutive identifier one or more times, the substitutive broadcast data including a same content as the broadcast data and time information indicating the reproduction start time.

22. A transmitter, comprising:
a first transmission unit operable to transmit broadcast data including time information indicating a first reproduction start time, the broadcast data being a piece of still images that constitute a moving picture and have sequential reproduction start times respectively, and both a first receiver and second receiver trying to obtain the broadcast data; and
a second transmission unit operable to transmit, at least a predetermined amount of time prior to a time when the first transmission unit transmits the broadcast data, substitutive broadcast data and a substitutive identifier one or more times, the substitutive broadcast data being a piece of still images that constitute the moving picture, and including time information indicating a second reproduction start time that is next to the first reproduction start time among the sequential reproduction start times, the substitutive identifier being for identifying the substitutive broadcast data, and only the second receiver trying to obtain the substitutive broadcast data and the substitutive identifier.

23. A transmitter, comprising:
a first transmission unit operable to transmit broadcast data including time information indicating a reproduction start time, the broadcast data including a plurality of data elements, and both a first receiver and a second receiver trying to obtain the broadcast data; and
a second transmission unit operable to transmit, at least a predetermined amount of time prior to a time when the first transmission unit transmits the broadcast data, substitutive broadcast data and a substitutive identifier one or more times, the substitutive broadcast data including a predetermined member among the data elements and time information indicating the reproduction start time, the substitutive identifier being for identifying the substitutive broadcast data, and only the second receiver trying to obtain the substitutive broadcast data.

24. The transmitter according to claim 23, wherein
the broadcast data constitutes a GOP (Group of Picture) encoded by MPEG (Moving Picture Expert Group) method, and the substitutive broadcast data constitutes an I-picture, which is a data element included in the GOP.

25. The transmitter according to claim 23, wherein
the broadcast data constitutes a GOP (Group of Picture) encoded by MPEG (Moving Picture Expert Group) method, and the substitutive broadcast data constitutes an I-picture and a P-picture, which are data elements included in the GOP.

26. The broadcast data transmission/reception method used for a broadcast data transmission/reception system that includes a transmitter, a first receiver and a second receiver, the transmitter transmitting broadcast data including time information indicating a reproduction start time, both the first and second receivers trying to obtain the broadcast data, and the broadcast data transmission/reception method comprising steps of:
transmitting, by the transmitter, substitutive broadcast data and a substitutive identifier one or more times at least a predetermined amount of time prior to transmitting the broadcast data, the substitutive broadcast data including a same content as the broadcast data and time information indicating the reproduction start time, and the substitutive identifier being for identifying the substitutive broadcast data;
trying, by the second receiver that includes a storing unit for storing therein an identifier specifier for specifying the substitutive identifier, to obtain the substitutive broadcast data based on the substitutive identifier specified by the identifier specifier; and
reproducing, at the reproduction start time, one of the broadcast data and the substitutive broadcast data if successfully obtained.

27. A broadcast data transmission/reception method used for a broadcast data transmission/reception system that includes a transmitter, a first receiver and a second receiver, the transmitter transmitting broadcast data including time information indicating a first reproduction start time, the broadcast data being a piece of still images that constitute a moving picture and have sequential reproduction start times respectively, both the first and second receivers trying to obtain the broadcast data, and the broadcast data transmission/reception method comprising steps of:
transmitting, by the transmitter, substitutive broadcast data and a substitutive identifier one or more times at least a predetermined amount of time prior to transmitting the broadcast data, the substitutive broadcast data being a piece of still images that constitute the moving picture, and including time information indicating a second reproduction start time that is next to the first reproduction start time among the sequential reproduction start times, and the substitutive identifier being for identifying the substitutive broadcast data;
trying, by the second receiver that includes a storing unit for storing therein an identifier specifier for specifying the substitutive identifier, to obtain the substitutive broadcast data based on the substitutive identifier specified by the identifier specifier, and to obtain the broadcast data based on the identifier; and
reproducing, at the first reproduction start time, the broadcast data if successfully obtained, and reproducing, at the second reproduction start time, the substitutive broadcast data if successfully obtained.

28. A broadcast data transmission/reception method used for a broadcast data transmission/reception system that includes a transmitter, a first receiver and a second receiver, the transmitter transmitting broadcast data including time information indicating a reproduction start time, the broadcast data including a plurality of data elements, both the first and second receivers trying to obtain the broadcast data, and the broadcast data transmission/reception method comprising steps of:
transmitting, by the transmission system, substitutive broadcast data and a substitutive identifier one or more times at least a predetermined amount of time prior to transmitting the broadcast data, the substitutive broadcast data including a predetermined member among the data elements and time information indicating the reproduction start time, and the substitutive identifier being for identifying the substitutive broadcast data;
trying, by the second receiver that includes a storing unit for storing therein an identifier specifier for specifying the substitutive identifier, to obtain the substitutive broadcast data based on the substitutive identifier specified by the identifier specifier; and
reproducing, at the reproduction start time, only the broadcast data if successfully obtained, and reproducing, at the reproduction start time, the substitutive broadcast data only if the broadcast data has not been obtained and only the substitutive broadcast data has been obtained.
